(19) United States
(12) Patent Application Publication
(10) Pub. No.: US 2017/0127697 A1
(43) Pub. Date: May 11, 2017

(54) Method for Manufacturing Baked Confectionery

(71) Applicant: Meiji Co., Ltd., Tokyo (JP)

(72) Inventors: Noriyuki Hirota, Saitama (JP); Tadashi Matsuura, Saitama (JP); Hiroyuki Utsunomiya, Tokyo (JP)

(73) Assignee: Meiji Co., Ltd., Tokyo (JP)

(21) Appl. No.: 15/323,182

(22) PCT Filed: Jul. 6, 2015
(86) PCT No.: PCT/JP2015/069433

§ 371 Date: Dec. 30, 2016

(30) Foreign Application Priority Data
Jul. 8, 2014 (JP) 2014-140616

(51) Int. Cl. A23G 1/30; A23G 1/00

(52) U.S. Cl. CPC A23G 1/30; A23G 1/00

(57) ABSTRACT

There is disclosed a method for manufacturing baked confectionery, comprising: a step of adding water and polyglycerol polyricinoleate to an fat-based confectionery dough; a step of molding the resulting fat-based confectionery dough into a predetermined shape; and a step of baking the molded product. According to this manufacturing method, handleability and workability during molding of the fat-based confectionery dough can be ensured, while improving the shape retention during baking of the fat-based confectionery.

### TECHNICAL FIELD

The present invention relates to confectionery obtained by adding water and polyglycerol polyricinoleate to fat-based confectionery, followed by baking.

### BACKGROUND ART

Chocolate is a kind of confectionery containing sugar, cacao mass, cocoa butter, and milk powder as main ingredients. At high temperatures, for example in summer, the surface of chocolate becomes sticky, and when the chocolate is held with a hand, the melted chocolate may stick to the hand, which is undesired in terms of quality. Patent Literature 1 discloses a technique for manufacturing chocolate by baking, whereby chocolate that does not become sticky when held with a hand even in summer is manufactured.

### CITATION LIST

### Patent Literature

Patent Literature 1: Japanese Unexamined Patent Publication No. S52-148662

### SUMMARY OF INVENTION

### Technical Problem

In baking chocolate, however, it has been difficult to manufacture confectionery with a satisfactory shape, because of so-called spreading out during baking, which results in a significant deformation in shape due to melting of chocolate during baking.

### Solution to Problem

The present inventors thus invented a method for manufacturing confectionery, wherein fat-based confectionery is baked while maintaining its original shape, and the confectionery also has satisfactory workability during molding. In summary, the present invention is as set forth below.

(1) A method for manufacturing baked confectionery, comprising: a step of adding water and polyglycerol polyricinoleate to an fat-based confectionery dough; a step of molding the resulting water-containing fat-based confectionery dough into a predetermined shape; and a step of baking the molded dough.
(2) The method for manufacturing baked confectionery according to (1), wherein the step of adding water and polyglycerol polyricinoleate to an fat-based confectionery dough includes adding polyglycerol polyricinoleate after adding water to the fat-based confectionery dough.
(3) The method for manufacturing baked confectionery according to (1) or (2), wherein an amount of water added is 0.5 wt % or more and 3 wt % or less by weight of the water-containing fat-based confectionery dough.
(4) The method for manufacturing baked confectionery according to any one of (1) to (3), wherein the baked confectionery has a center portion having a different composition.
(5) The method for manufacturing baked confectionery according to (4), wherein the center portion having a different composition is fat-based confectionery.

### Advantageous Effects of Invention

According to the present invention, handleability and workability during molding of the fat-based confectionery dough can be ensured, while improving the shape retention during baking of the fat-based confectionery.

### DESCRIPTION OF EMBODIMENTS

Embodiments for carrying out the present invention will be described hereinafter in detail.

In the method for manufacturing baked confectionery of the present invention, baked confectionery is obtained by adding water and polyglycerol polyricinoleate to an fat-based confectionery dough, molding the resulting dough into a predetermined shape, and then baking the molded dough. The fat-based confectionery used in an embodiment of the present invention is not limited to chocolate and semi-chocolate defined under the “Fair Competition Rules Concerning the Labeling of Chocolate”, which are the rules approved by the Japan Fair Trade Commission, such as dark chocolate, milk chocolate, and white chocolate, and may also be a product that does not use cacao mass or cocoa butter as a main fat-based ingredient, such as chocolate cream or nut cream, as long as the product attains the effects of the present invention.

In an embodiment of the present invention, water to be added to the fat-based confectionery dough may be added alone, or may be added in the form of an ingredient containing water, such as a fruit juice or starch syrup. It is preferable that the amount of the water added be 0.5 to 3.0 wt % by weight of the water containing fat-based confectionery dough. Within this range, the workability of the water-containing fat-based confectionery dough is satisfactory, and the shape retention of the molded fat-based confectionery during baking is satisfactory.

In an embodiment of the present invention, polyglycerol polyricinoleate is added to the fat-based confectionery dough. It is preferable that the amount of polyglycerol polyricinoleate added be 0.05 to 0.5%, and more preferably 0.1 to 0.5%, by weight of the water-containing fat-based confectionery dough. Within this range, the workability of the water-containing fat-based confectionery dough is satisfactory, and the shape retention of the molded fat-based confectionery during baking is satisfactory.

In an embodiment of the present invention, when water and polyglycerol polyricinoleate are added to the fat-based confectionery dough, it is preferable to initially add water to the fat-based confectionery dough and mix them with stirring, and then add polyglycerol polyricinoleate. When water and polyglycerol polyricinoleate are added in this order, the viscosity of the resulting water-containing fat-based confectionery dough for baking can be kept low, which is more advantageous for improving the workability, and the effect of retaining the shape of the baked confectionery can be maintained. If the viscosity of the fat-based confectionery dough is high, the following problems may occur: for example, when depositing the fat-based confectionery dough with a depositor, variations in weight may be produced, or during molding bottom in a process of molding center-filled fat-based confectionery for baking, the fat-based confectionery may not extend entirely due to poor extensibility of the fat-based confectionery dough, resulting in the formation of a gap in the shell. It is preferable that the viscosity at 35° C. of the fat-based confectionery dough having satisfactory workability during molding be 80000 cps or less. The lower limit of the viscosity may be 40000 cps, or may be 50000 cps, although not particularly limited thereto. The viscosity of the fat-based confectionery dough is measured by measuring a viscosity at 35° C. or 40° C. using a Brookfield viscometer, unless otherwise specified. The viscosity is measured at a speed of 4 rpm with a No. 6 rotor.

In an embodiment of the present invention, the method of molding the water-containing fat-based confectionery dough for baking is not particularly limited. The water-containing fat-based confectionery dough for baking may be deposited on a flat plate with a depositor, or may be molded with a mold. The water-containing fat-based confectionery dough for baking may be molded alone, or may be combined with another food product with a different composition. When the water-containing fat-based confectionery dough for baking is combined with another food product with a different composition, in the step of molding the water-containing fat-based confectionery dough for baking into a predetermined shape, the water-containing fat-based confectionery dough for baking may be deposited in a mold, and then a core may be pressed into the mold to mold the water-containing fat-based confectionery dough for baking into a predetermine shape such as a concave shape to form a shell portion. The manufacturing method according to an embodiment of the present invention may also include, prior to the step of baking the molded shell portion, the step of depositing another food product with a different composition into the cavity of the shell portion to form a center portion, and may further include the step of depositing the water-containing fat-based confectionery dough for baking onto the formed center portion to form a covering. When the water-containing fat-based confectionery dough for baking is chocolate, the shell portion can be formed by, for example, pressing a cooled core into the mold in which the chocolate has been deposited, and cooling and solidifying the chocolate. Examples of food products used as the center portion include, but are not particularly limited to, fat-based confectionery such as cream and chocolate, aqueous confectionery such as syrup and jam, and baked confectionery such as cookies and biscuits.

The manufacturing method according to an embodiment of the present invention is suitable for obtaining baked confectionery by baking composite confectionery in which the shell portion or center portion is made of fat-based confectionery, and is particularly suitable when fat-based confectionery having a low melting point or high fat content is used as the center. This is because the addition of water and polyglycerol polyricinoleate to the fat-based confectionery dough that constitutes the shell portion improves the workability during molding of a thin shell, and the shell portion suppresses deformation of the fat-based confectionery in the center portion due to melting during baking. The manufacturing method according to an embodiment of the present invention is particularly suitable when other chocolate is included using a shell-making method or one-shot deposition method, for example, which requires good extensibility for molding the shell thinly and uniformly, as well as shape retention during baking.

In an embodiment of the present invention, the molded water-containing chocolate for baking is baked in an oven, for example. It is preferable to bake chocolate at 100° C. or higher and 300° C. or lower, and preferably at 160° C. or higher and 250° C. or lower. At a baking temperature of 100° C. or higher, a favorable taste or texture of the baking confectionery tends to be achieved. Additionally, at a baking temperature of 300° C. or lower, a burnt smell of the baked confectionery does not become excessively strong, and the baked confectionery does not become excessively hard, which is preferable.

### EXAMPLES

The present invention will be described hereinafter in more detail with reference to examples, which are not intended to limit the technical scope of the present invention.

### Example 1

### (Preparation of a Water-Containing Chocolate Dough for Shell)

A chocolate base dough made of 33 parts by weight of sugar, 12 parts by weight of cacao mass, 4 parts by weight of cocoa powder, 16 parts by weight of cocoa butter, 6 parts by weight of a vegetable fat (trade name: Melano SS from Fuji Oil Co., Ltd.), 26 parts by weight of whole milk powder, 2 parts by weight of lactose, 0.5 parts by weight of lecithin, and 0.5 parts by weight of a flavor was manufactured using a common method for manufacturing chocolate. The viscosity at 40° C. of the resulting chocolate base dough was 50000 cps. The temperature of 87.3 parts by weight of the resulting chocolate base dough was adjusted to 35° C., and then 2 parts by weight of a vegetable fat (trade name: Melano SS from Fuji Oil Co., Ltd.), 7 parts by weight of isomaltulose, 1.5 parts by weight of 1,3-dibehenyl-2-oleoylglycerol, and 1.5 parts by weight of sugar were added thereto and mixed. Further, 0.6 parts by weight of water was added and mixed to obtain a water-containing chocolate base dough. The viscosity at 35° C. of the resulting water-containing chocolate base dough was 125000 cps. Further, 0.1 parts by weight of polyglycerol polyricinoleate (trade name: Sunsoft 818 from Taiyo Kagaku Co., Ltd.) was added and mixed to obtain a water-containing chocolate dough for a shell. The viscosity at 35° C. of the resulting water-containing chocolate dough for a shell was 60000 cps. The resulting water-containing chocolate dough for a shell was easy to handle.

(Preparation of Powdered Green Tea (Maccha) Cream for Center)

In accordance with a common method for manufacturing chocolate, 10 parts by weight of sugar, 35 parts by weight of a vegetable fat, 25 parts by weight of whole milk powder, 29.5 parts by weight of lactose, and 0.5 parts by weight of lecithin were used as ingredients and mixed, and the mixture was ground and combed with a refiner to obtain a white chocolate dough. The temperature of 79.5 parts by weight of the resulting white chocolate dough was adjusted to 35° C., and then 3 parts by weight of powdered green tea (maccha), 14 parts by weight of a vegetable fat, 1.5 parts by weight of 1,3-dibehenyl-2-oleoylglycerol, 1.5 parts by weight of sugar, and 0.5 parts by weight of a flavor were added thereto and mixed to obtain a powdered green tea (maccha) cream dough for the center.

(Manufacture of Chocolate for Baking)

2.5 g of the resulting water-containing chocolate dough for a shell was deposited on a mold of which inner dimensions had a length of about 16 mm, a width of about 16 mm, and a depth of about 16 mm. A core with a length of 12 mm, a width of 12 mm, and a height of 16 mm, which had been cooled to −10° C., was pressed into the mold containing the chocolate dough, the chocolate dough was cooled and solidified, and excess chocolate overflowing from the top surface of the mold was removed to obtain a shell with a thickness of about 2.5 mm. The weight of the resulting shell was 2.2 g. Into the resulting shell, 1.6 g of the powdered green tea (maccha) cream dough for the center was deposited. Further, 0.8 g of the water-containing chocolate dough for a shell was deposited thereon. The chocolate dough overflowing from the mold top surface was removed to form a flat top surface. This was cooled and solidified to obtain chocolate for baking having its entire surface covered with the water-containing chocolate for a shell. The weight of the resulting chocolate for baking was 4.4 g.

(Baking of Chocolate for Baking)

The resulting chocolate for baking was baked in an oven at 200° C. for 3 minutes to obtain baked confectionery. The resulting baked confectionery was of good quality, with little deformation and no stickiness when held with a hand.

### Example 2

In the same manner as in Example 1, 2.0 parts by weight of a vegetable fat, 7.0 parts by weight of isomaltulose, 1.5 parts by weight of 1,3-dibehenyl-2-oleoylglycerol, and 1.5 parts by weight of sugar were added and mixed into 87.3 parts by weight of the chocolate base dough. Further, 0.5 parts by weight of water was added and mixed to obtain a water-containing chocolate base dough, and then 0.2 parts by weight of polyglycerol polyricinoleate as an emulsifier was added thereto to prepare a water-containing chocolate dough for a shell, which was then molded and baked to obtain baked confectionery.

### Comparative Examples 1-6

Various water-containing chocolate doughs for shells were prepared by changing the emulsifier for addition into the chocolate dough for a shell in Example 2 from polyglycerol polyricinoleate to various emulsifiers, and the resulting water-containing chocolate doughs for shells were molded and baked to obtain various types of baked confectionery.

### Referential Example 1

A chocolate dough for a shell was prepared as in Example 2, except that water and an emulsifier were not added, and the chocolate dough for a shell was molded and baked to obtain baked confectionery.

### Referential Example 2

A water-containing chocolate dough for a shell was prepared as in Example 2, except that an emulsifier was not added, and the chocolate dough was molded and baked to obtain baked confectionery.

Viscosities of the water-containing chocolate doughs for shells in Example 2, Comparative Examples 1 to 6, and Referential Example 2 and of the chocolate dough for a shell in Referential Example 1 were measured, and handling of the doughs during molding was evaluated. The shape of each of the resulting various types of baked confectionery was also evaluated. The results are shown in Tables 1 and 2.

TABLE 1

| | | HLB of | | | | | |
|---|---|---|---|---|---|---|---|
| | | Emulsifier | | Comparative | Comparative | Comparative | Comparative |
| | | Added | Example 2 | Example 1 | Example 2 | Example 3 | Example 4 |
| Formula of | Water- | | 87.8 | 87.8 | 87.8 | 87.8 | 87.8 |
| Chocolate | Containing | | | | | | |
| Dough for | Chocolate Base | | | | | | |
| Shell | Dough | | | | | | |
| | Chocolate Base | | — | — | — | — | — |
| | Dough | | | | | | |
| | Vegetable Fat | | 2 | 2 | 2 | 2 | 2 |
| | Isomaltulose | | 7 | 7 | 7 | 7 | 7 |
| | 1,3-Dibehenyl-2- | | 1.5 | 1.5 | 1.5 | 1.5 | 1.5 |
| | Oleoylglycerol | | | | | | |
| | Sugar | | 1.5 | 1.5 | 1.5 | 1.5 | 1.5 |
| | Polyglycerol | — | 0.2 | — | — | — | — |
| | Polyricinoleate | | | | | | |
| | Lecithin | — | — | 0.2 | — | — | — |
| | Sucrose Erucate | 2 | — | — | 0.2 | — | — |
| | Sorbitan | 2.1 | — | — | — | 0.2 | — |
| | Trioleate | | | | | | |
| | Decaglyceryl | 3.7 | — | — | — | — | 0.2 |
| | Erucate | | | | | | |
| | Diglycerin | 7.3 | — | — | — | — | — |
| | Monooleate | | | | | | |
| | Pentaglycerin | 13 | — | — | — | — | — |
| | Monomyristate | | | | | | |

| | | | | | |
|---|---|---|---|---|---|
| Viscosity of Chocolate Dough | 43500 | 64250 | 57500 | 76000 | 64000 |
| for Shell | | | | | |
| Workability during Shell | A | B | A | C | B |
| Molding | | | | | |
| Shape Retention of Baked | A | D | C | A | A |
| Confectionery | | | | | |
| Others | | When held | | When held | When held |
| | | with a hand, | | with a hand, | with a hand, |
| | | fat or oil | | fat or oil | fat or oil |
| | | sticks to the | | sticks to the | sticks to the |
| | | hand | | hand | hand |

| | | Comparative | Comparative | Referential | Referential | Trade Name |
|---|---|---|---|---|---|---|
| | | Example 5 | Example 6 | Example 1 | Example 2 | of Emulsifier |
| Formula of | Water- | 87.8 | 87.8 | — | 88 | |
| Chocolate | Containing | | | | | |
| Dough for | Chocolate Base | | | | | |
| Shell | Dough | | | | | |
| | Chocolate Base | — | — | 88 | — | |
| | Dough | | | | | |
| | Vegetable Fat | 2 | 2 | 2 | 2 | |
| | Isomaltulose | 7 | 7 | 7 | 7 | |
| | 1,3-Dibehenyl-2- | 1.5 | 1.5 | 1.5 | 1.5 | |
| | Oleoylglycerol | | | | | |
| | Sugar | 1.5 | 1.5 | 1.5 | 1.5 | |
| | Polyglycerol | — | — | — | — | Sunsoft 818 |
| | Polyricinoleate | | | | | |
| | Lecithin | — | — | — | — | Lecithin |
| | Sucrose Erucate | — | — | — | — | Sugar Ester ER-290 |
| | Sorbitan | — | — | — | — | Emasol O-30V |
| | Trioleate | | | | | |
| | Decaglyceryl | — | — | — | — | OE-750 |
| | Erucate | | | | | |
| | Diglycerin | 0.2 | — | — | — | Poem DO-100V |
| | Monooleate | | | | | |
| | Pentaglycerin | — | 0.2 | — | — | Sunsoft A-141E |
| | Monomyristate | | | | | |

| | | | | |
|---|---|---|---|---|
| Viscosity of Chocolate Dough | 86250 | 83500 | 51500 | 87500 |
| for Shell | | | | |
| Workability during Shell | C | C | A | C |
| Molding | | | | |
| Shape Retention of Baked | B | C | D | A |
| Confectionery | | | | |
| Others | | | Without | |
| | | | addition of | |
| | | | water | |

Workability during Shell Molding A: Excellent, B: Satisfactory, C: Poor
Shape Retention of the Baked Confectionery A: Excellent, B: Satisfactory, C: Poor, D: Very Poor

TABLE 2

| | | | Evaluation | |
|---|---|---|---|---|
| | Width | Height | of Shape | |
| | (mm) | (mm) | Retention | Others |
| (before | 17.0 | 18.0 | — | |
| Baking) | | | | |
| Example 2 | 19.9 | 12.9 | A | |
| Comparative | 21.5 | 11.4 | D | When held with a finger, |
| Example 1 | | | | fat or oil sticks to the finger |
| Comparative | 20.3 | 12.4 | C | |
| Example 2 | | | | |
| Comparative | 19.3 | 12.9 | A | When held with a finger, |
| Example 3 | | | | fat or oil sticks to the finger |
| Comparative | 19.6 | 12.8 | A | When held with a finger, |
| Example 4 | | | | fat or oil sticks to the finger |
| Comparative | 20.2 | 12.6 | B | |
| Example 5 | | | | |
| Comparative | 20.3 | 12.4 | C | |
| Example 6 | | | | |
| Referential | 21.9 | 12.5 | D | |
| Example 1 | | | | |
| Referential | 19.3 | 13.4 | A | |
| Example 2 | | | | |

Shape Retention of the Baked Confectionery
A: Excellent,
B: Satisfactory,
C: Poor,
D: Very Poor

### Comparative Example 1

The water-containing chocolate dough for a shell to which lecithin was added had a viscosity lower than that of the water-containing chocolate dough for a shell of Referential Example 2 to which an emulsifier was not added, and also had satisfactory workability during molding. However, the shape retention during baking was very poor, and the resulting baked confectionery had a very poor shape, and was of an undesired quality.

### Comparative Example 2

The water-containing chocolate dough for a shell to which sucrose erucate was added had a viscosity lower than that of the water-containing chocolate dough for a shell of Referential Example 2 to which an emulsifier was not added, and also had excellent workability during molding. However, the shape retention during baking was poor, and the resulting baked confectionery had a poor shape, and was of an undesired quality.

### Comparative Example 3

The water-containing chocolate dough for a shell to which sorbitan trioleate was added had a viscosity slightly lower than that of the water-containing chocolate dough for a shell of Referential Example 2 to which an emulsifier was not added, but had no improvement in workability during molding. The shape retention during baking was excellent, and the shape of the resulting baked confectionery was excellent. The resulting baked confectionery, however, was of an undesired quality in that when it was held with a finger, the fat or oil stuck to the hand.

### Comparative Example 4

The water-containing chocolate dough for a shell to which decaglyceryl erucate was added had a viscosity lower than that of the water-containing chocolate dough for a shell of Referential Example 2 to which an emulsifier was not added, and also had satisfactory workability during molding. Although the shape retention during baking was excellent, and the shape of the resulting baked confectionery was excellent, the resulting baked confectionery was of an undesired quality in that when it was held with a finger, the fat or oil stuck to the hand.

### Comparative Example 5

The water-containing chocolate dough for a shell to which diglycerin monooleate was added had a viscosity comparable to that of the water-containing chocolate dough for a shell of Referential Example 2 to which an emulsifier was not added, and had no improvement in workability during molding. The shape retention during baking was satisfactory, and the resulting baked confectionery had a satisfactory shape, and was of a desired quality.

### Comparative Example 6

The water-containing chocolate dough for a shell to which pentaglycerin monomyristate was added had a viscosity comparable to that of the water-containing chocolate dough for a shell of Referential Example 2 to which an emulsifier was not added, and had no improvement in workability during molding. The shape retention during baking was poor, and the resulting baked confectionery had a poor shape, and was of an undesired quality.

### Example 3

The temperature of 87.1 parts by weight of the chocolate base dough used in Example 1 was adjusted to 35° C., and then 2 parts by weight of a vegetable fat (trade name: Melano SS from Fuji Oil Co., Ltd.), 7.2 parts by weight of isomaltulose, 1.5 parts by weight of 1,3-dibehenyl-2-oleoylglycerol, and 1.5 parts by weight of sugar were added thereto and mixed. Further, 0.6 parts by weight of water was added and mixed to obtain a water-containing chocolate base dough. The viscosity at 35° C. of the resulting water-containing chocolate base dough was 125000 cps. Further, 0.1 parts by weight of polyglycerol polyricinoleate (trade name: Sunsoft 818 from Taiyo Kagaku Co., Ltd.) was added and mixed to obtain a water-containing chocolate dough for a shell. The viscosity at 35° C. of the resulting water-containing chocolate dough for a shell was 62500 cps. The resulting water-containing chocolate dough for a shell was easy to handle. Baked confectionery was obtained in the same manner as that in Example 1, using the resulting water-containing chocolate dough for a shell and the powdered green tea (maccha) cream for the center used in Example 1. The resulting baked confectionery was of good quality, with little deformation and no stickiness when held with a hand.

### Example 4

The temperature of 87.1 parts by weight of the chocolate base dough used in Example 1 was adjusted to 35° C., and then 2 parts by weight of a vegetable fat (trade name: Melano SS from Fuji Oil Co., Ltd.), 7.2 parts by weight of isomaltulose, 1.5 parts by weight of 1,3-dibehenyl-2-oleoylglycerol, and 1.5 parts by weight of sugar were added and mixed. Further, 0.1 parts by weight of polyglycerol polyricinoleate (trade name: Sunsoft 818 from Taiyo Kagaku Co., Ltd.) was added and mixed. The viscosity of the resulting chocolate base dough was 42500 cps. To the chocolate base dough, 0.6 parts by weight of water was added and mixed to obtain a water-containing chocolate dough for a shell. The viscosity at 35° C. of the resulting water-containing chocolate dough for a shell was 85000 cps. The resulting water-containing chocolate dough for a shell had extensibility inferior to that in Example 3, making the molding operation rather difficult. Baked confectionery was obtained in the same manner as that in Example 1, using the resulting water-containing chocolate dough for a shell and the powdered green tea (maccha) cream for the center used in Example 1. The resulting baked confectionery was of good quality, with little deformation and no stickiness when held with a hand.

It was found that when water and polyglycerol polyricinoleate are added to a chocolate dough, the addition of water first further improves the shape retention of the resulting baked confectionery, and keeps the viscosity of the water-containing chocolate dough low, leading to an improvement in workability during molding.

Table 3 shows dough viscosities before the addition of water and the emulsifier, after primary addition, and after complete addition when producing the water-containing chocolate doughs for shells in Examples 3 and 4, as well as yield values of the produced water-containing chocolate doughs for shells.

TABLE 3

| | Viscosity (cps) | | | |
|---|---|---|---|---|
| | before Addition of | | | |
| | Water and | after Primary | after Complete | Yield |
| | Emulsifier | Addition | Addition | Value |
| Example 3 | 68750 | 125000 | 62500 | 5.72 |
| | | (Addition | | |
| | | of Water) | | |
| Example 4 | 66250 | 42500 | 85000 | 21.57 |
| | | (Addition of | | |
| | | Emulsifier) | | |

It was found that the order in which the emulsifier and water are added makes a difference in the viscosity (after complete addition) of the final water-containing chocolate dough, as well as in the yield value. In Example 3, the viscosity of the dough after the addition of water (after primary addition) was higher than that before the addition; however, the viscosity of the dough decreased after the addition of the emulsifier (after complete addition), and the viscosity of the dough after complete addition was slightly lower than that before the addition of water and the emulsifier. In Example 4, the viscosity of the dough after the addition of the emulsifier (after primary addition) was lower than that before the addition; however, the viscosity of the dough increased after the addition of water (after complete addition), and the viscosity of the dough after complete addition was higher than that before the addition of water and the emulsifier. Further, the viscosity of the dough after complete addition was lower in Example 3 than in Example 4, and the yield value of the dough was also significantly lower in Example 3 than in Example 4.

Table 4 shows, for the baked confectionery of Examples 3 and 4, the results obtained by examining the degree of spreading out during baking after baking on an aluminum plate with feet, as well as the results of the evaluation of shape retention based on these results.

TABLE 4

| | Size after Baking | | | |
|---|---|---|---|---|
| | Average | Maximum | Average | Evaluation |
| | Width | Width | Height | of Shape |
| | (mm) | (mm) | (mm) | Retention |
| (before | 17.0 | — | 18.00 | — |
| Baking) | | | | |
| Example 3 | 19.54 | 20.18 | 13.51 | B |
| Example 4 | 20.18 | 20.52 | 13.29 | B |

Shape Retention of the Baked Confectionery
A: Excellent,
B: Satisfactory,
C: Poor,
D: Very Poor

While the baked confectionery of both Examples 3 and 4 was of good quality with little spreading out during baking, the baked confectionery of Example 3 obtained by adding water first had a tendency to exhibit less spreading out during baking.

1. A method for manufacturing baked confectionery, comprising:
a step of adding water and polyglycerol polyricinoleate to a fat-based confectionery dough;
a step of molding the resulting water-containing fat-based confectionery dough into a predetermined shape; and
a step of baking the molded dough.

2. The method for manufacturing baked confectionery according to claim 1, wherein
the step of adding water and polyglycerol polyricinoleate to a fat-based confectionery dough includes adding polyglycerol polyricinoleate after adding water to the fat-based confectionery dough.

3. The method for manufacturing baked confectionery according to claim 1, wherein
an amount of water added is 0.5 wt % or more and 3 wt % or less by weight of the water-containing fat-based confectionery dough.

4. The method for manufacturing baked confectionery according to claim 1, wherein
the baked confectionery has a center portion having a different composition.

5. The method for manufacturing baked confectionery according to claim 4, wherein
the center portion having a different composition is fat-based confectionery.

6. The method for manufacturing baked confectionery according to claim 2, wherein
an amount of water added is 0.5 wt % or more and 3 wt % or less by weight of the water-containing fat-based confectionery dough.

7. The method for manufacturing baked confectionery according to claim 2, wherein
the baked confectionery has a center portion having a different composition.

8. The method for manufacturing baked confectionery according to claim 3, wherein
the baked confectionery has a center portion having a different composition.

9. The method for manufacturing baked confectionery according to claim 6, wherein
the baked confectionery has a center portion having a different composition.

10. The method for manufacturing baked confectionery according to claim 7, wherein
the center portion having a different composition is fat-based confectionery.

11. The method for manufacturing baked confectionery according to claim 8, wherein
the center portion having a different composition is fat-based confectionery.

12. The method for manufacturing baked confectionery according to claim 9, wherein
the center portion having a different composition is fat-based confectionery.
